(19) United States
(12) Patent Application Publication
(10) Pub. No.: US 2026/0131404 A1
(43) Pub. Date: May 14, 2026

(54) METHOD OF MANUFACTURING WAFER AND WAFER MANUFACTURING SYSTEM

(71) Applicant: DISCO CORPORATION, Tokyo (JP)

(72) Inventor: Nobuki KAKIUCHI, Tokyo (JP)

(21) Appl. No.: 19/358,642

(22) Filed: Oct. 15, 2025

(30) Foreign Application Priority Data
Nov. 14, 2024 (JP) 2024-198914

(51) Int. Cl. B23K 26/53; B23K 26/08; B23K 101/40

(52) U.S. Cl. CPC B23K 26/53; B23K 26/083; B23K 26/0869; B23K 2101/40

(57) ABSTRACT

A method of manufacturing a wafer from an ingot includes preparing the ingot that has a wafer forming region corresponding to the wafer and an outer circumferential excess region including an outer circumferential surface of the ingot and surrounding the wafer forming region, while a focused spot of a laser beam that is transmittable through the ingot is being positioned within the ingot, applying the laser beam to a region of the ingot that is disposed inwardly of the outer circumferential surface of the ingot while, at the same time, moving the ingot and the focused spot relatively to each other, thereby forming a separation layer that terminates short of the outer circumferential surface of the ingot within at least the wafer forming region of the ingot, processing the outer circumferential excess region of the ingot to expose a side surface of the wafer forming region.

### BACKGROUND OF THE INVENTION

### Field of the Invention

The present invention relates to a method of manufacturing a wafer from an ingot and a wafer manufacturing system.

### Description of the Related Art

A process of manufacturing device chips uses a wafer as a workpiece to be processed into the device chips. The wafer has a plurality of devices constructed in respective areas demarcated thereon by a grid of streets or projected dicing lines established on the wafer. According to the manufacturing process, the wafer is divided along the streets into individual pieces including the respective devices as the device chips. The device chips will be incorporated in various electronic appliances such as cellular phones and personal computers, for example.

Generally, a wafer is fabricated by slicing a cylindrical ingot with a wire saw. However, since the wire saw includes a wire whose diameter is equal to or larger than a thickness of the wafer, the wire saw finds it difficult to process the ingot with accuracy. For slicing an ingot with a wire saw, it is necessary to provide a certain cutting allowance, making it unavoidable for the ingot to produce a considerable amount of a material of the ingot that is to be wasted as saw dust without becoming part of a wafer to be fabricated from the ingot. Consequently, the number of wafers that can be produced from a single ingot is unduly limited, and the cost of the wafers is increased.

There has been proposed a method of forming a separation layer including modified regions and cracks in an ingot by applying a laser beam to the ingot (see, for example, JP 2016-111143A). Since the separation layer is more fragile than the remainder of the ingot, when an external force is applied to the ingot with the separation layer formed therein, the ingot is divided along the separation layer that functions as a separation initiating point, separating a thin slice as a wafer along the separation layer from the remainder of the ingot. The proposed method is effective to reduce the amount of the material of the ingot that is wasted when a wafer is separated from the ingot. As a result, wafers can be fabricated from ingots with a high level of productivity.

### SUMMARY OF THE INVENTION

In order to separate a wafer appropriately from an ingot according to the proposed method, it is desirable to form a high-quality separation layer in the ingot. It has been confirmed in the art that ingots are likely to have crystal defects on their outer circumferential surfaces and in their vicinity. When a laser beam is applied to form a separation layer in an ingot with crystal defects, the laser beam is also applied to the crystal defects on the outer circumferential surface of the ingot and in its vicinity, tending to change the properties of portions of the separation layer and allow cracks developed by the application of the laser beam to extend in unexpected directions. For this reason, the formed separation layer is likely to be relatively low in quality and may not properly function as a separation initiating point. As a result, a wafer may not appropriately be separated along the separation layer from the ingot.

The present invention has been made in view of the problems described above. It is an object of the present invention to provide a method of manufacturing a wafer and a wafer manufacturing system that make it possible to promote the appropriate separation of a wafer from an ingot.

In accordance with an aspect of the present invention, there is provided a method of manufacturing a wafer from a crystalline ingot, including preparing the ingot that has a wafer forming region corresponding to the wafer and an outer circumferential excess region including an outer circumferential surface of the ingot and surrounding the wafer forming region, while a focused spot of a laser beam that is transmittable through the ingot is being positioned within the ingot, applying the laser beam to a region of the ingot that is disposed inwardly of the outer circumferential surface of the ingot while, at the same time, moving the ingot and the focused spot relatively to each other, thereby forming a separation layer that terminates short of the outer circumferential surface of the ingot within at least the wafer forming region of the ingot, and processing the outer circumferential excess region of the ingot to expose a side surface of the wafer forming region.

Preferably, the side surface of the wafer forming region is exposed after the forming the separation layer, and the exposing the side surface of the wafer forming region includes exposing the separation layer on the side surface of the wafer forming region. Preferably, the method further includes dividing the ingot along the separation layer that functions as a separation initiating point to produce the wafer from the ingot after the forming the separation layer and the exposing the side surface of the wafer forming region.

Further preferably, the preparing the ingot includes inspecting the ingot to determine whether or not there is an anomalous section including at least one of a crystal defect region where a crystal defect exists, a polymorphism region that has its crystal form different from the crystal form of another region, or an anomalous concentration region where concentration of an impurity contained in the ingot falls out of an allowable range, and, if it is decided that the anomalous section exists in a predetermined range from the outer circumferential surface of the ingot, establishing the outer circumferential excess region in order for the outer circumferential excess region to contain the anomalous section.

Further preferably, the exposing the side surface of the wafer forming region includes removing a region extending from the outer circumferential surface of the ingot to the wafer forming region. Preferably, the exposing the side surface of the wafer forming region includes forming a groove having a depth from a surface of the ingot to the separation layer along an outer circumferential edge of the wafer forming region.

In accordance with another aspect of the present invention, there is provided a wafer manufacturing system for manufacturing a wafer from a crystalline ingot, including a laser processing apparatus for, in a state where a focused spot of a laser beam that is transmittable through the ingot that has a wafer forming region corresponding to the wafer and an outer circumferential excess region including an outer circumferential surface of the ingot and surrounding the wafer forming region is being positioned within the ingot, applying the laser beam to a region of the ingot that is disposed inwardly of the outer circumferential surface of the ingot while, at the same time, moving the ingot and the focused spot relatively to each other, thereby forming a separation layer that terminates short of the outer circumferential surface of the ingot within at least the wafer forming region of the ingot, and an exposing apparatus for processing the outer circumferential excess region of the ingot to expose a side surface of the wafer forming region.

Preferably, the wafer manufacturing system further includes a separating apparatus for dividing the ingot along the separation layer that functions as a separation initiating point.

With the method of manufacturing a wafer according to the aspect of the invention and the wafer manufacturing system according to the other aspect of the invention, the separation layer that functions as a separation initiating point at the time of separating a wafer from the ingot is formed in the ingot such that the separation layer terminates short of the outer circumferential surface of the ingot. The laser beam that is applied for forming the separation layer is less liable to be applied to crystal defects that may occur in the outer circumferential surface and its vicinity, resulting in an increase in the quality of the separation layer. As a consequence, the wafer can easily be separated from the ingot.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1A is a perspective view of an ingot;

FIG. 1B is a plan view of the ingot;

FIG. 2 is a flowchart of a sequence of successive steps of a method of manufacturing a wafer according to an embodiment of the present invention;

FIG. 3A is a plan view of the ingot in an inspecting step of the method;

FIG. 3B is a plan view of the ingot in an outer circumferential excess region establishing step of the method;

FIG. 4A is a perspective view of the ingot in a separation layer forming step of the method;

FIG. 4B is a cross-sectional view of the ingot after the separation layer forming step of the method;

FIG. 5A is a front elevational view, partly in cross section, illustrating the ingot during a cutting process performed on the ingot in an exposing step of the method;

FIG. 5B is a front elevational view, partly in cross section, illustrating the ingot during another cutting process performed on the ingot in the exposing step of the method;

FIG. 6 is a front elevational view, partly in cross section, illustrating the ingot during a grinding process performed on the ingot in the exposing step of the method;

FIG. 7A is a front elevational view, partly in cross section, of a separating apparatus that is holding the ingot;

FIG. 7B is a front elevational view, partly in cross section, of the separating apparatus that is separating a wafer from the ingot in a separating step of the method;

FIG. 8 is a front elevational view, partly in cross section, illustrating the ingot in a planarizing step of the method;

FIG. 9 is a front elevational view, partly in cross section, illustrating the ingot in an exposing step according to a modification;

FIG. 10A is a front elevational view, partly in cross section, illustrating the ingot while a groove is being formed therein by a cutting process; and

FIG. 10B is a front elevational view, partly in cross section, illustrating the ingot while a groove is being formed therein by a laser beam applying process.

### DETAILED DESCRIPTION OF THE PREFERRED EMBODIMENT

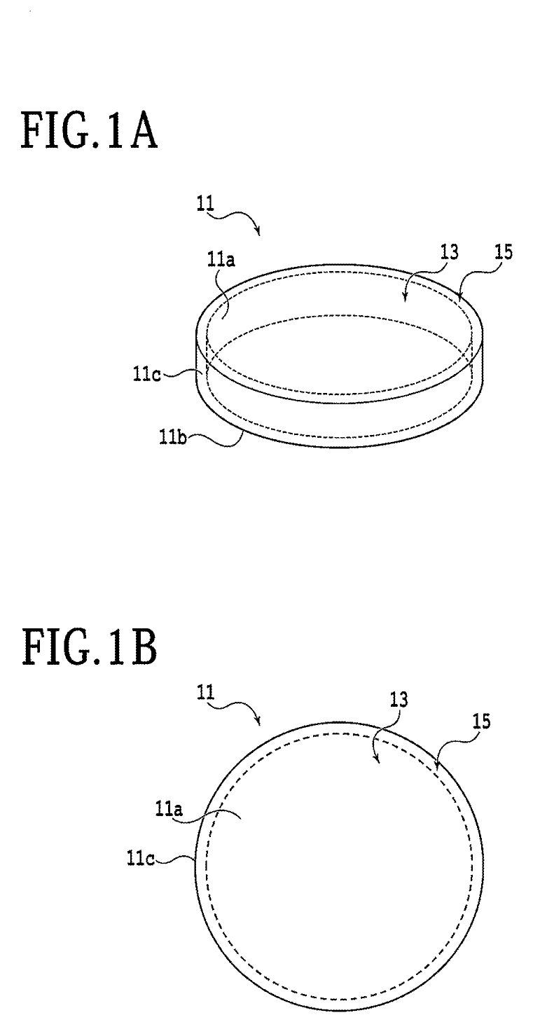

A method of manufacturing a wafer according to an embodiment of the present invention will be described below with reference to the accompanying drawings. First, a structural example of an ingot that can be used in the method of manufacturing a wafer according to the present embodiment will be described below with reference to FIGS. 1A and 1B. FIG. 1A illustrates the ingot, denoted by 11, in perspective, and FIG. 1B illustrates the ingot 11 in plan.

The ingot 11 is a base material from which to manufacture a wafer or substrate and typically refers to a cylindrical ingot that is crystalline in nature. A thin piece will be separated as a wafer having a predetermined thickness from the remainder of the ingot 11. For example, the ingot 11 is a monocrystalline ingot made of a semiconductor material such as silicon, silicon carbide (SiC), gallium nitride, or gallium oxide, for example. Therefore, when a thin piece is separated from the ingot 11, it is obtained as a monocrystalline semiconductor wafer from the remainder of the ingot 11.

The ingot 11 has a first surface, i.e., a face side, 11a, a second surface, i.e., a reverse side, 11b positioned opposite the first surface 11a, and an outer circumferential surface, i.e., a side surface, 11c joined to the outer circumferential edges of the first surface 11a and the second surface 11b. The first surface 11a and the second surface 11b lie essentially parallel to each other, and the outer circumferential surface 11c extends essentially perpendicularly to the first surface 11a and the second surface 11b. The ingot 11 has a diameter selected depending on the diameter, e.g., 6 inches or 8 inches, of wafers to be manufactured therefrom. The ingot 11 may have in its outer circumferential surface a recess such as an orientation flat indicative of the crystal orientation of the ingot 11.

The ingot 11 includes a wafer forming region 13 corresponding to wafers to be manufactured therefrom and an outer circumferential excess region 15 surrounding the wafer forming region 13. In FIGS. 1A and 1B, the wafer forming region 13 and the outer circumferential excess region 15 are depicted as being separate from each other along a hypothetical boundary indicated by the broken lines.

The wafer forming region 13 refers to a cylindrical region including a center of the ingot 11 and represents a region to be separated as wafers from the ingot 11 in a subsequent step of the method, for example. Of the ingot 11, the wafer forming region 13 will essentially be used to form wafers. The wafer forming region 13 has a diameter commensurate with the diameter of wafers to be separated from the ingot 11. However, the diameter of the wafer forming region 13 may be larger than the diameter of wafers to be used eventually as products. Specifically, after a thin piece has been separated from the wafer forming region 13 as a wafer having the same diameter as the wafer forming region 13, the wafer may be processed in another step to fabricate a final wafer having a desired diameter, e.g., 6 inches or 8 inches.

The outer circumferential excess region 15 refers to a hollow cylindrical region including the outer circumferential surface 11c of the ingot 11 and represents a region extending radially inwardly over a predetermined distance, e.g., 50 mm, from the outer circumferential surface 11c of the ingot 11. As described later, the outer circumferential excess region 15 is to be removed in a process of separating a wafer from the ingot 11 and will not essentially be used to form wafers.

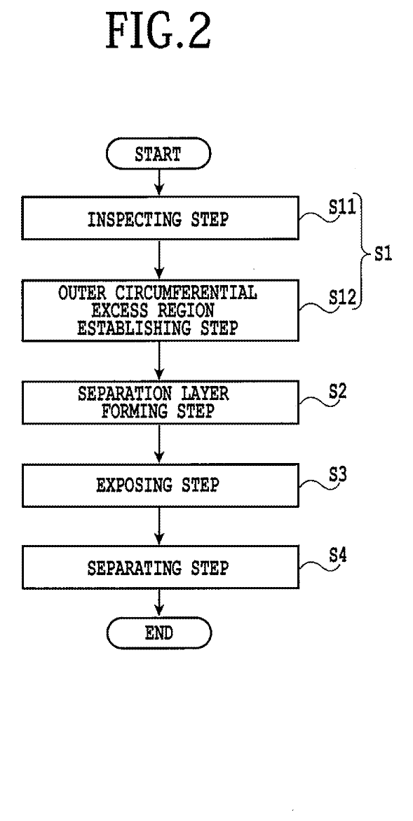

A specific example of the method of manufacturing a wafer from the ingot 11 will be described below. FIG. 2 is a flowchart of a sequence of successive steps of the method of manufacturing a wafer according to the present embodiment. The steps of the method of manufacturing a wafer according to the present embodiment will be described in detail below.

For manufacturing a wafer from the ingot 11, first, the ingot 11 including the wafer forming region 13 and the outer circumferential excess region 15 is prepared in preparing step S1. In preparing step S1, the ingot 11 illustrated in FIGS. 1A and 1B is prepared. An implementer of the method of manufacturing a wafer according to the present embodiment may produce the ingot 11 on its own or may acquire the ingot 11 from another manufacturer.

In preparing step S1, the wafer forming region 13 and the outer circumferential excess region 15 are established on the ingot 11. Specifically, the wafer forming region 13 and the outer circumferential excess region 15 are designated such that the wafer forming region 13 is essentially equalized in shape and size to the wafer to be manufactured from the ingot 11.

In preparing step S1, the wafer forming region 13 and the outer circumferential excess region 15 may be established in order for the outer circumferential excess region 15 to contain a certain anomalous section included in the ingot 11. Specifically, preparing step S1 optionally includes inspecting step S11 for inspecting whether an anomalous section exists in the ingot 11 or not and outer circumferential excess region establishing step S12 for establishing an outer circumferential excess region based on the position of an anomalous section detected in inspecting step S11.

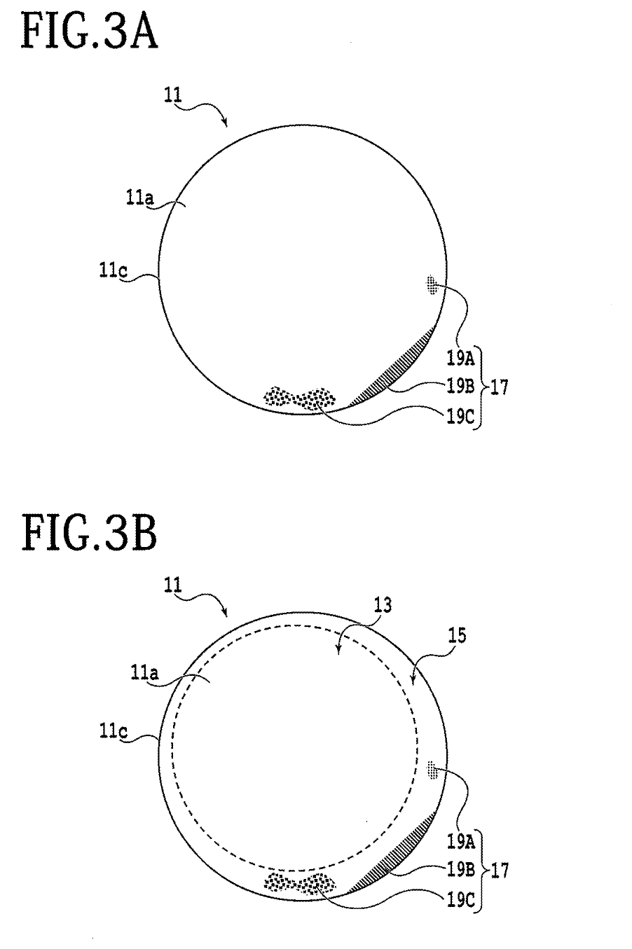

FIG. 3A illustrates, in plan, the ingot 11 in inspecting step S11. As illustrated in FIG. 3A, the ingot 11 may include a crystal defect region 19A where a crystal defect exists, a polymorphism region 19B that has its crystal form different from the crystal form of another region, and an anomalous concentration region 19C where the concentration of an impurity contained in the ingot 11 falls out of an allowable range. In inspecting step S11, for example, one, two, or all of the crystal defect region 19A, the polymorphism region 19B, and the anomalous concentration region 19C is/are detected as an anomalous section 17.

The crystal defect region 19A refers to a region where a crystal defect exists, and is different in crystallinity from another region, i.e., a region where no crystal defect exists, of the ingot 11. The polymorphism region 19B refers to a region that is different in crystal form from another region and has its crystallinity different from the crystallinity of another region of the ingot 11. Therefore, it is possible to inspect whether the crystal defect region 19A and the polymorphism region 19B exist or not by measuring the crystallinity of the ingot 11.

There is no limitation on how to inspect the crystallinity of the ingot 11. For example, the crystallinity of the ingot 11 can be detected by photoluminescence, an observation using an electron microscope such as a scanning electron microscope (SEM) or a scanning transmission electron microscope (STEM) or an optical microscope, X-ray topography, or a Raman spectroscopy, for example. If the crystal defect region 19A and the polymorphism region 19B are detected by inspecting the ingot 11, then the positions and ranges of the crystal defect region 19A and the polymorphism region 19B are recorded.

It has been confirmed in the art that the crystal defect region 19A and the polymorphism region 19B are likely to occur in the outer circumferential surface 11c of the ingot 11 and its vicinity. It is assumed that this phenomenon is caused by the fact that a temperature gradient is developed in the ingot 11 during the process of crystal growth of the ingot 11 and the crystallinity of the ingot 11 tends to be disturbed by a temperature difference between the inside of the ingot 11 and the outer circumferential surface 11c.

Moreover, the ingot 11 may contain an impurity of a material that is different from the material of the ingot 11. If a region where the concentration of an impurity is anomalous exists in the ingot 11, then it may possibly adversely affect the quality of wafers manufactured from the ingot 11. For example, the ingot 11 may accidentally contain an impurity, and a region where the concentration of the impurity is high may exist in the ingot 11. Furthermore, an impurity, e.g., a dopant, for controlling the electric characteristics of the ingot 11 may intentionally be added to the ingot 11. Ideally, a dopant should be uniformly dispersed in the ingot 11. Actually, the concentration of the dopant is liable to differ across the ingot 11, so that the ingot 11 tends to contain a region where the dopant is excessive and/or a region where the dopant is insufficient.

In inspecting step S11, the concentration of an impurity contained in the ingot 11 may be measured and the ingot 11 may be inspected to check whether it has an anomalous concentration region 19C where the concentration of an impurity falls out of an allowable range or not. The concentration of an impurity contained in the ingot 11 may be measured by any method. For example, the concentration of an impurity may be measured on the basis of the specific resistance value of the ingot 11 that has been measured by an eddy current method or the fluorescence spectrum of the ingot 11 that has been measured by a spectrofluorometer. Furthermore, the concentration of an impurity may be specified by X-ray fluorescence analysis (XRF), X-ray photoelectron spectroscopy (XPS), energy dispersive X-ray spectroscopy (EDX), or Auger electron spectroscopy (AES), for example.

After the concentration of an impurity contained in the ingot 11 has been measured, it is confirmed whether an anomalous concentration region 19C where the concentration of an impurity falls out of an allowable range exists in the ingot 11 or not. Specifically, an upper limit value and/or a lower limit value for the concentration of an impurity are/is established in advance, and the ingot 11 is inspected to detect whether a region where the concentration of an impurity is higher than the upper limit value and/or lower than the lower limit value exists in the ingot 11 or not. If an anomalous concentration region 19C is detected, then the position and range of the anomalous concentration region 19C are recorded.

The allowable range for the concentration of an impurity is established depending on the material of the ingot 11 and the use of wafers to be separated from the ingot 11, for example. By way of example, it is supposed that the ingot 11 is made of SiC and the concentration of an impurity, i.e., a dopant, is determined on the basis of the specific resistance value of the ingot 11 that has been measured by an eddy current method. In this case, an allowable range for the specific resistance value of the ingot 11 is set to a range of ±10 mΩ·cm, preferably ±5 mΩ·cm, from a reference value, i.e., an ideal value of specific resistance, for example. If a region where the specific resistance value falls out of the allocable range exists in the ingot 11, then it is determined that the concentration of the dopant also falls out of its allowable range in the same region, and the region is established as the anomalous concentration region 19C.

The crystal defect region 19A, the polymorphism region 19B, and the anomalous concentration region 19C are established as the anomalous section 17 according to the above examination of the ingot 11, and the position and range of the anomalous section 17 in the ingot 11 are recorded. In inspecting step S11, however, one or two of the crystal defect region 19A, the polymorphism region 19B, and the anomalous concentration region 19C may be established as the anomalous section 17. Moreover, a given region other than the crystal defect region 19A, the polymorphism region 19B, and the anomalous concentration region 19C may be established as the anomalous section 17.

FIG. 3B illustrates, in plan, the ingot 11 in outer circumferential excess region establishing step S12. In outer circumferential excess region establishing step S12, if it is decided that an anomalous section 17 exists within a predetermined range from the outer circumferential surface 11c of the ingot 11 in inspecting step S11, then an outer circumferential excess region 15 is established on the ingot 11 such that the anomalous section 17 is included in the outer circumferential excess region 15.

Specifically, first, on the basis of the position and range of the anomalous section 17 detected in inspecting step S11, it is confirmed whether the anomalous section 17 exists in a target region within the predetermined range from the outer circumferential surface 11c of the ingot 11. If the anomalous section 17 exists in the target region, then an outer circumferential excess region 15 is established on the ingot 11 such that the anomalous section 17 is included in the outer circumferential excess region 15. In this manner, the wafer forming region 13 and the outer circumferential excess region 15 can be designated such that the anomalous section 17 existing in an outer circumferential portion of the ingot 11 may be not included in the wafer forming region 13.

The wafer forming region 13 and the outer circumferential excess region 15 may not have their centers aligned with each other. If the anomalous section 17 is localized in a certain region of the ingot 11, e.g., a lower right region of the ingot 11 as illustrated in FIG. 3B, then the wafer forming region 13 may have its center shifted out of alignment with the center of the ingot 11 away from the region where the anomalous section 17 is localized, i.e., toward an upper left side in FIG. 3B. In this fashion, the anomalous section 17 can be included in the outer circumferential excess region 15 while the wafer forming region 13 keeps its diameter at a certain level or larger.

Next, the ingot 11 prepared in preparing step S1 is processed to fabricate a wafer from the ingot 11. Specifically, separation layer forming step S2, exposing step S3, and separating step S4 (see FIG. 2) are successively carried out to separate a wafer from the ingot 11. Specific examples of these steps will be described below.

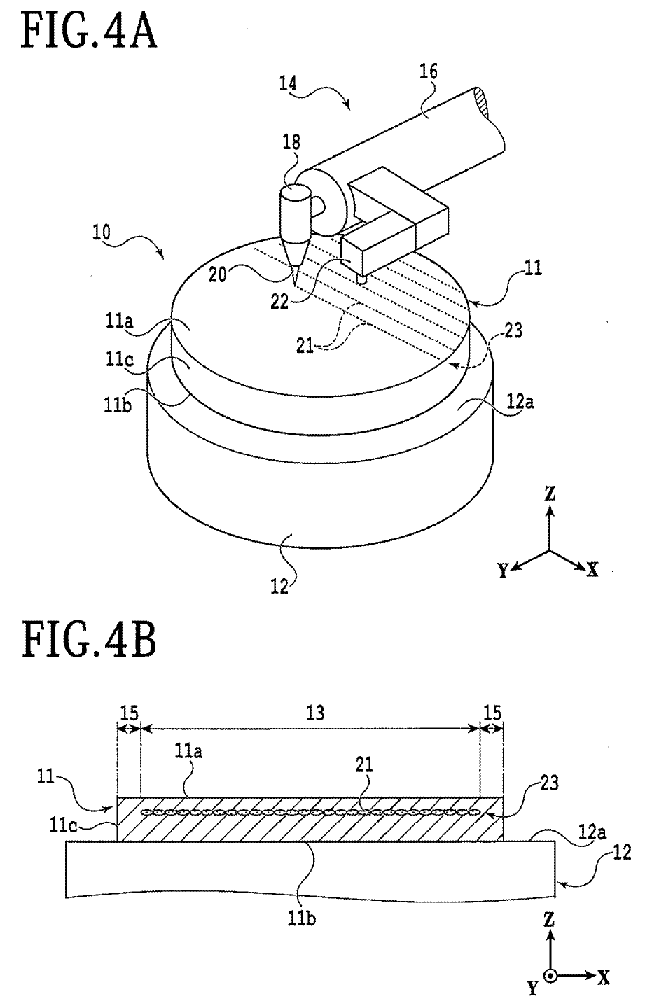

FIG. 4A illustrates, in perspective, the ingot 11 in separation layer forming step S2. In separation layer forming step S2, a laser beam applying process is performed on the ingot 11 by a laser processing apparatus 10 to form a separation layer in the ingot 11 that functions as a separation initiating point. In FIG. 4A and other figures, an X-axis represented by the arrow X and a Y-axis represented by the arrow Y extend horizontally perpendicularly to each other. The X-axis indicates first horizontal directions or leftward and rightward directions whereas the Y-axis indicates second horizontal directions or forward and rearward directions. A Z-axis represented by the arrow Z extends vertically perpendicularly to the X-axis and the Y-axis. The Z-axis indicates vertical directions, upward and downward directions, or heightwise directions.

The laser processing apparatus 10 includes a chuck table or holding table 12 for holding the ingot 11 thereon. The chuck table 12 has a circular upper surface that lies flatwise generally parallel to a horizontal plane defined as an XY plane along the X-axis and the Y-axis. The upper surface of the chuck table 12 functions as a holding surface 12a for holding the ingot 11 thereon. The holding surface 12a is fluidly connected to a suction source, not depicted, such as an ejector, for example, through a fluid channel, not depicted, defined in the chuck table 12 and a valve, not depicted.

The chuck table 12 is coupled to a moving unit, not depicted, that moves the chuck table 12 and a rotary actuator, not depicted, that rotates the chuck table 12. The moving unit includes ball-screw-type moving mechanisms, for example, for moving the chuck table 12 in horizontal directions, i.e., in an XY plane along the X-axis and the Y-axis. The rotary actuator includes an electric motor, for example, for rotating the chuck table 12 about its central axis generally parallel to the Z-axis.

The laser processing apparatus 10 also includes a laser beam applying unit 14 for applying a laser beam 20 to the ingot 11 on the chuck table 12. The laser beam applying unit 14 includes a laser oscillator, not depicted, such as an yttrium aluminum garnet (YAG) laser, an yttrium orthovanadate (YVO₄) laser, or an yttrium lithium fluoride (YLF) laser for emitting the pulsed laser beam 20 and a housing 16 and a laser processing head 18 that are disposed above the chuck table 12. The housing 16 is of a hollow cylindrical shape that houses the laser oscillator therein and extends along the Y-axis. The laser processing head 18 is mounted on a distal end of the housing 16 and applies the laser beam 20 emitted from the laser oscillator downwardly toward the chuck table 12.

The housing 16 and the laser processing head 18 house therein an attenuator for adjusting the output level of the laser beam 20 emitted from the laser oscillator and an optical system for guiding the laser beam 20 emitted from the laser oscillator to the ingot 11 held on the chuck table 12. The optical system includes optical elements such as a lens, a mirror, a polarizing beam splitter (PBS), a diffractive optical element (DOE), and a liquid crystal on silicon–spatial light modulator (LCOS-SLM), for example. The optical system controls various parameters of the laser beam 20, e.g., the direction along which the laser beam 20 travels, the cross-sectional shape of the laser beam 20, and the position where the laser beam 20 is focused.

The laser processing head 18 houses therein a beam condenser, not depicted, as a component of the optical system. The beam condenser includes a condensing lens such as an fθ lens and applies a focused spot of the laser beam 20 onto the ingot 11. The laser beam applying process is performed on the ingot 11 by the laser beam 20 applied from the laser processing head 18 to the ingot 11.

An image capturing unit 22 for capturing an image of a subject is mounted on the laser beam applying unit 14. For example, the image capturing unit 22 is fixed to the housing 16 and disposed adjacent to the laser processing head 18. The image capturing unit 22 includes an image sensor such as a charge-coupled-device (CCD) sensor or a complementary metal-oxide semiconductor (CMOS) sensor, for example. The image capturing unit 22 captures an image of the ingot 11 held on the chuck table 12, etc. The image capturing unit 22 may be of any type and include a visible-light camera or an infrared-ray camera, for example. When the image capturing unit 22 captures an image of the ingot 11, it acquires a captured image of the ingot 11. On the basis of the captured image acquired by the image capturing unit 22, the ingot 11 and the laser processing head 18 are positioned with regard to each other, and the state of the ingot 11 is confirmed.

The housing 16 may be coupled to a moving unit, not depicted, that moves the housing 16. The moving unit includes a ball-screw-type moving mechanism, for example, for moving the housing 16 together with the laser processing head 18 and the image capturing unit 22 vertically along the Z-axis, i.e., lifting and lowering them along the Z-axis. The laser processing head 18 and the image capturing unit 22 are moved along the Z-axis to adjust the vertical position of the focused spot of the laser beam 20 and the focusing of the image capturing unit 22.

In separation layer forming step S2, first, the ingot 11 is held on the chuck table 12. For example, the ingot 11 is placed on the chuck table 12 such that the first surface 11a is exposed upwardly and the second surface 11b faces the holding surface 12a. Then, the suction source is actuated to apply a suction force, i.e., a negative pressure, to the holding surface 12a to hold the ingot 11 under suction on the chuck table 12.

Then, the laser beam applying unit 14 is energized to apply the laser beam 20 from the laser processing head 18 to the ingot 11. The ingot 11 is now processed by the laser beam 20 applied thereto. The laser beam 20 is applied to the ingot 11 under such conditions as to form a separation layer that functions as a separation initiating point in the ingot 11. Specifically, the laser beam 20 is applied to the ingot 11 under such conditions as to modify or alter regions in the ingot 11 that are irradiated with the laser beam 20 into modified or altered regions 21. More specifically, the wavelength of the laser beam 20 is set such that at least part of the laser beam 20 is transmitted through the ingot 11. In other words, the laser beam 20 is a pulsed laser beam that is transmittable through the ingot 11. Other conditions under which to apply the laser beam 20 to the ingot 11 are established to form the modified regions 21 appropriately in the ingot 11. If the ingot 11 is an SiC ingot, for example, then the conditions under which to apply the laser beam 20 to the ingot 11 may be established as follows:

Wavelength: 1064 nm

Average output power: 2 to 4.5 W

Repetitive frequency: 80 kHz

Processing feed speed: 120 to 260 mm/s

For applying the laser beam 20 to the ingot 11, first, the image capturing unit 22 captures an image of the ingot 11, acquiring a captured image of the first surface 11a of the ingot 11. On the basis of the captured image, a positional relation between the ingot 11 and the laser processing head 18 is adjusted. Specifically, the positions of the chuck table 12 along the X-axis and the Y-axis are adjusted to position the focused spot of the laser beam 20 at an end portion of the ingot 11 as viewed in plan. In addition, the vertical position of the focused spot of the laser beam 20 is adjusted to align with the vertical position of a point in the ingot 11, i.e., between the first surface 11a and the second surface 11b. The difference between the vertical position of the first surface 11a of the ingot 11 and the vertical position of the focused spot of the laser beam 20 corresponds to the depth of the modified regions 21 formed in the ingot 11.

Then, while the laser processing head 18 is applying the laser beam 20 to the ingot 11, the chuck table 12 is moved along the X-axis at a predetermined processing feed speed, thereby moving, i.e., processing-feeding, the ingot 11 and the focused spot of the laser beam 20 relatively to each other along the X-axis. Therefore, while the focused spot of the laser beam 20 is being positioned within the ingot 11, the laser beam 20 is applied to the ingot 11 at the first surface 11a and scans the ingot 11 along the X-axis, forming a modified region 21 in the ingot 11 along the X-axis.

Thereafter, the chuck table 12 is moved a predetermined indexing distance, i.e., in the range from 250 to 400 µm, along the Y-axis, so that the ingot 11 and the laser processing head 18 are moved relatively to each other, i.e., indexing-fed, along the Y-axis. Then, while the laser processing head 18 is applying the laser beam 20 to the ingot 11, the chuck table 12 is processing-fed along the X-axis in the same manner as described above. The above process is repeated until a plurality of modified regions 21 that are generally parallel to each other are formed at predetermined spaced intervals in the ingot 11 at a predetermined depth therein.

The laser beam 20 may be applied to the ingot 11 while the chuck table 12 is being processing-fed only in one direction along the X-axis or alternately in both directions along the X-axis. Instead of moving the chuck table 12, the laser processing head 18 may be moved to scan the ingot 11 with the laser beam 20. Rather than moving the chuck table 12 or the laser processing head 18, the laser beam applying unit 14 may incorporate a scanning optical system for performing scanning with the laser beam 20 over the ingot 11. For example, such a scanning optical system may include optical elements such as a galvanoscanner, an acoustooptical deflector (AOD), and a polygon mirror.

When the laser beam 20 is applied to the ingot 11, a region within the ingot 11 where the focused spot of the laser beam 20 is positioned and its periphery are expanded, disturbing or distorting their crystal structure and hence modifying the ingot 11. As a result, a linear modified region 21 is formed along the X-axis in the ingot 11. In the modified region 21, internal stresses act to produce a plurality of minute cracks that develop from the modified region 21 along directions across the thicknesswise directions of the ingot 11.

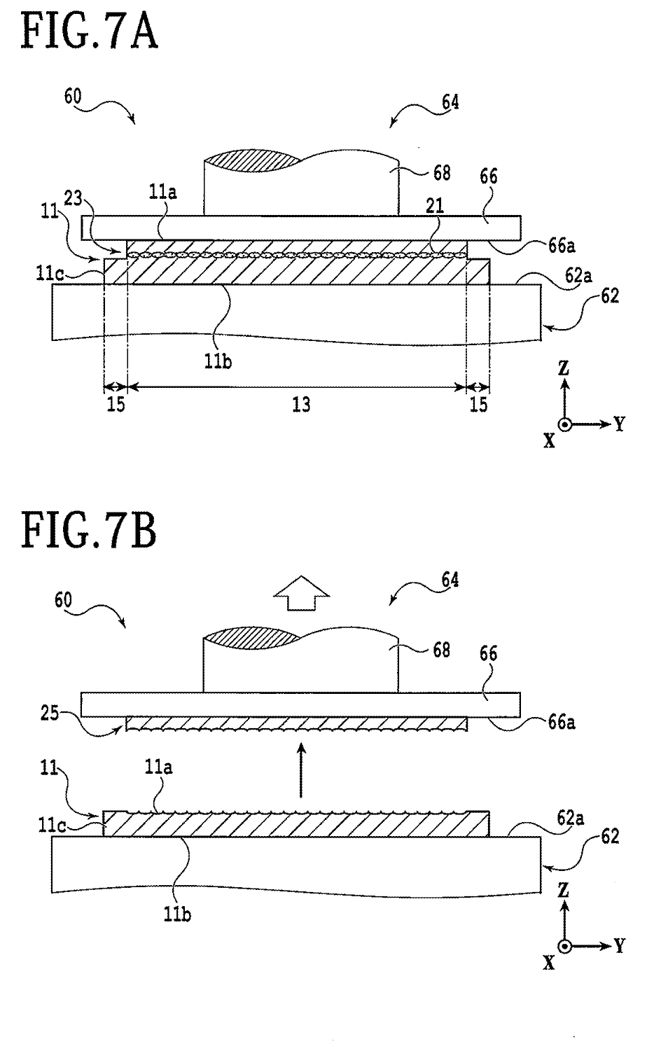

A plurality of modified regions 21 are formed at predetermined spaced intervals in the ingot 11 until the modified regions 21 and the cracks exist entirely in the ingot 11. The modified regions 21 and the cracks jointly make up a separation layer, i.e., a modified layer or altered layer, 23 at a predetermined depth in the ingot 11. The depth at which the separation layer 23 exists in the ingot 11, i.e., the distance between the first surface 11a of the ingot 11 and the separation layer 23, corresponds to the thickness of a wafer (see FIG. 7B) to be separated from the ingot 11 in a subsequent step.

According to the present embodiment, the laser beam 20 is applied to the ingot 11 radially inwardly of the outer circumferential surface 11c of the ingot 11. Specifically, the laser beam 20 scans the wafer forming region 13 (see FIGS. 1A and 1B) of the ingot 11, but is not applied to the outer circumferential excess region 15 (see FIGS. 1A and 1B) or is applied to only a portion of the outer circumferential excess region 15 that is positioned adjacent to the wafer forming region 13. Therefore, the laser beam 20 is not applied to a predetermined range from the outer circumferential surface 11c of the ingot 11, i.e., a portion of the outer circumferential excess region 15 or the outer circumferential excess region 15 in its entirety.

FIG. 4B illustrates, in cross section, the ingot 11 after separation layer forming step S2. If the laser beam 20 is applied to only the wafer forming region 13, then modified regions 21 are formed in the wafer forming region 13, but not in the outer circumferential excess region 15 as the laser beam 20 is not applied thereto. As a result, a separation layer 23 formed in the ingot 11 terminates short of the outer circumferential surface 11c and is not exposed at the outer circumferential surface 11c.

As described above, in the outer circumferential surface 11c and its vicinity, crystal defects are likely to occur due to a temperature gradient developed in the ingot 11 during the process of crystal growth of the ingot 11, etc. If the laser beam 20 scans the ingot 11 fully thereacross from one end to the other, then the laser beam 20 is applied to an outer circumferential portion of the ingot 11 where the existence of crystal defects is highly possible. Consequently, the separation layer 23 may have its properties partly altered and/or cracks occurring from the modified regions 21 due to the application of the laser beam 20 may be developed in unexpected directions. As a result, the separation layer 23 may be lowered in quality and may not appropriately function as a separation initiating point. According to the present embodiment, however, the laser beam 20 is not applied to a predetermined range from the outer circumferential surface 11c of the ingot 11, as described above. The laser beam 20 is thus not liable to be applied to crystal defects, so that the separation layer 23 is prevented from being lowered in quality.

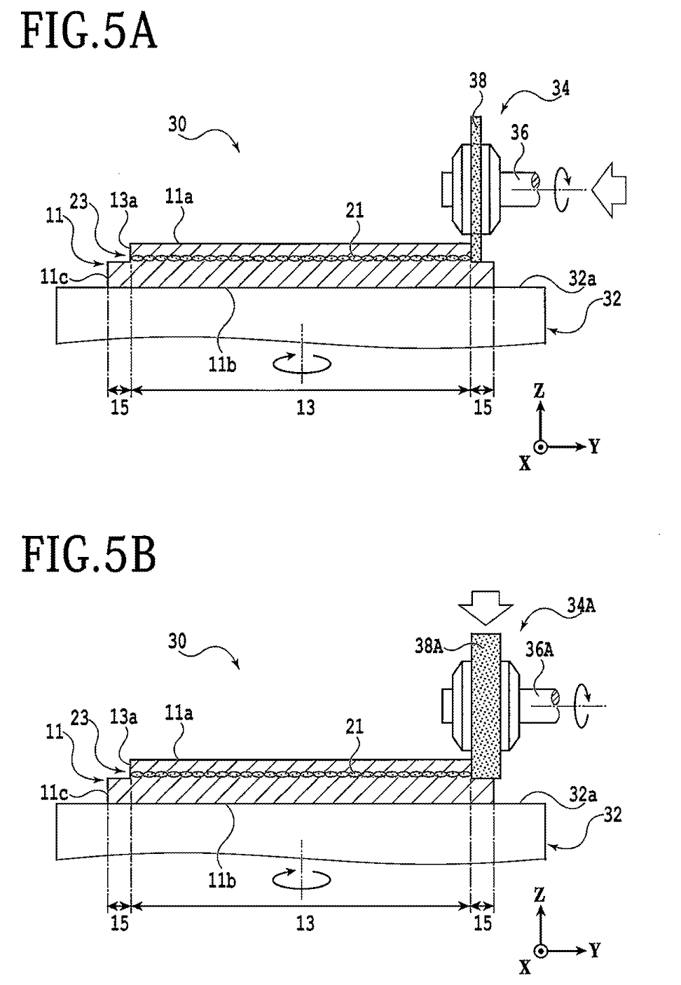

Then, the outer circumferential excess region 15 of the ingot 11 is processed to expose a side surface of the wafer forming region 13 in exposing step S3. FIG. 5A illustrates the ingot 11 during a cutting process performed on the ingot 11 in exposing step S3 in front elevation, partly in cross section. In exposing step S3, for example, the cutting process is performed on the ingot 11 by a cutting apparatus 30 to expose a side surface of the wafer forming region 13.

As illustrated in FIG. 5A, the cutting apparatus 30 includes a chuck table or holding table 32 for holding the ingot 11 thereon. The chuck table 32 has a circular upper surface that lies flatwise generally parallel to a horizontal plane defined as an XY plane along the X-axis and the Y-axis. The upper surface of the chuck table 32 functions as a holding surface 32a for holding the ingot 11 thereon. The holding surface 32a is fluidly connected to a suction source, not depicted, such as an ejector, for example, through a fluid channel, not depicted, defined in the chuck table 32 and a valve, not depicted.

The chuck table 32 is coupled to a moving unit, not depicted, that moves the chuck table 32 and a rotary actuator, not depicted, that rotates the chuck table 32. The moving unit includes a ball-screw-type moving mechanism, for example, for moving the chuck table 32 in horizontal directions along the X-axis. The rotary actuator includes an electric motor, for example, for rotating the chuck table 32 about its central axis generally parallel to the Z-axis.

The cutting apparatus 30 further includes a cutting unit 34 disposed above the chuck table 32 for performing the cutting process on the ingot 11. The cutting unit 34 includes a cylindrical spindle 36 extending along the Y-axis and an annular cutting blade 38 for cutting the ingot 11, fixedly mounted on a distal end portion, i.e., one end portion, of the spindle 36 by a fastener such as a nut, not depicted. The spindle 36 has a proximal end portion, i.e., an opposite end portion, coupled to a rotary actuator, not depicted, such as an electric motor for rotating the spindle 36 about its central axis generally parallel to the Y-axis. When the rotary actuator is energized to rotate the spindle 36 about its central axis, the cutting blade 38 is rotated about its central axis generally parallel to the Y-axis.

The cutting blade 38 may be a hub-type cutting blade, also referred to as a “hub blade,” for example. The hub blade includes a hub base made of a metal material such as aluminum alloy, for example, and an annular cutting edge disposed on and along an outer circumferential edge of the hub base. The cutting edge of the hub blade is made of an electroformed grindstone including abrasive grains of diamond or cubic boron nitride (cBN), for example, and a binder such as a nickel-plated layer binding the abrasive grains in place. The cutting blade 38 may alternatively be a washer-type cutting blade, also referred to as a “washer blade.” The washer blade includes abrasive grains and a binder of metal, ceramic, or resin, for example, that binds the abrasive grains in place.

The cutting unit 34 is coupled to a moving unit, not depicted, that moves the cutting unit 34. The moving unit includes ball-screw-type moving mechanisms, for example, for moving the cutting unit 34 in horizontal directions, i.e., an XY plane along the Y-axis and the Z-axis.

In exposing step S3, first, the ingot 11 is held on the chuck table 32. Specifically, the ingot 11 is placed on the chuck table 32 such that the first surface 11a is exposed upwardly and the second surface 11b faces the holding surface 32a. Then, the suction source is actuated to apply a suction force, i.e., a negative pressure, to the holding surface 32a to hold the ingot 11 under suction on the chuck table 32.

Then, the chuck table 32 and/or the cutting unit 34 are/is moved to adjust a positional relation between the ingot 11 and the cutting blade 38. Specifically, the chuck table 32 and the cutting unit 34 are set to respective positions to place the cutting blade 38 alongside of the ingot 11. At this time, the cutting unit 34 is placed to position the lowermost end of the cutting blade 38 either at the same height as the separation layer 23 formed in the ingot 11 or at a height below the separation layer 23.

Then, while the chuck table 32 and the cutting blade 38 are being rotated about their respective central axes, the chuck table 32 and the cutting unit 34 are moved relatively to each other in directions to bring the ingot 11 and the cutting blade 38 closer toward each other. For example, the cutting unit 34 is moved along the Y-axis toward the ingot 11 to bring the rotating cutting blade 38 into contact with the outer circumferential surface 11c of the ingot 11. The rotating cutting blade 38 is continuously moved to cut into the outer circumferential surface 11c, so that the outer circumferential surface 11c is cut in an annular pattern circumferentially around the ingot 11.

Thereafter, while the chuck table 32 and the cutting blade 38 are kept in rotation, the chuck table 32 and the cutting unit 34 are further moved relatively to each other to bring the cutting blade 38 toward the center of the ingot 11. The outer circumferential excess region 15 of the ingot 11 is thus progressively cut from the outer circumferential surface 11c toward the center of the ingot 11. The ingot 11 is continuously cut until the cutting blade 38 reaches the wafer forming region 13.

When the cutting blade 38 reaches the wafer forming region 13, an annular region of the ingot 11 that extends radially inwardly from the outer circumferential surface 11c to the wafer forming region 13 is cut off. Now, an annular step is formed in the outer circumferential portion of the ingot 11 on the first surface 11a side, exposing a side surface 13a of the wafer forming region 13. As a consequence, an end of the separation layer 23 formed in the ingot 11 is exposed on the side surface 13a of the wafer forming region 13.

In exposing step S3, as described above, the outer circumferential excess region 15 of the ingot 11 is processed to expose the side surface 13a of the wafer forming region 13, exposing the separation layer 23 on the side surface 13a. The outer circumferential excess region 15 may be processed otherwise providing the side surface 13a of the wafer forming region 13 can be exposed.

FIG. 5B illustrates the ingot 11 during another cutting process performed on the ingot 11 in exposing step S3 of the method in front elevation, partly in cross section. For example, in exposing step S3, the side surface 13a of the wafer forming region 13 may be exposed by cutting the outer circumferential excess region 15 with a cutting blade 38A illustrated FIG. 5A that is thicker than the cutting blade 38. Specifically, a cutting apparatus 30 illustrated in FIG. 5B includes a cutting unit 34A that is similar in structure and function to the cutting unit 34 illustrated in FIG. 5A except that the cutting blade 38A thicker than the cutting blade 38 is mounted on a distal end portion of a spindle 36A.

The thickness of the cutting blade 38A is equal to or larger than the width of the outer circumferential excess region 15 of the ingot 11, i.e., the distance from the outer circumferential surface 11c to the boundary between the wafer forming region 13 and the outer circumferential excess region 15. In exposing step S3, after the cutting blade 38A has been positioned directly above the outer circumferential excess region 15 of the ingot 11, the chuck table 32 and the cutting blade 38A are rotated about their respective axes. While the chuck table 32 and the cutting blade 38A are being rotated, the cutting unit 34A is lowered along the Z-axis to bring the cutting blade 38A into contact with the first surface 11a side of the outer circumferential excess region 15. The cutting unit 34A is continuously lowered to cut into the outer circumferential excess region 15 of the ingot 11 until the lowermost end of the cutting blade 38A reaches the separation layer 23.

When the lowermost end of the cutting blade 38A reaches the separation layer 23, an annular region extending from the outer circumferential surface 11c of the ingot 11 to the wafer forming region 13 is cut off. The side surface 13a of the wafer forming region 13 is now exposed, exposing the end of the separation layer 23 on the side surface 13a of the wafer forming region 13. For processing the outer circumferential excess region 15 of the ingot 11, therefore, the cutting blade 38A may cut into the first surface 11a side, i.e., the upper surface side, of the ingot 11, as described above.

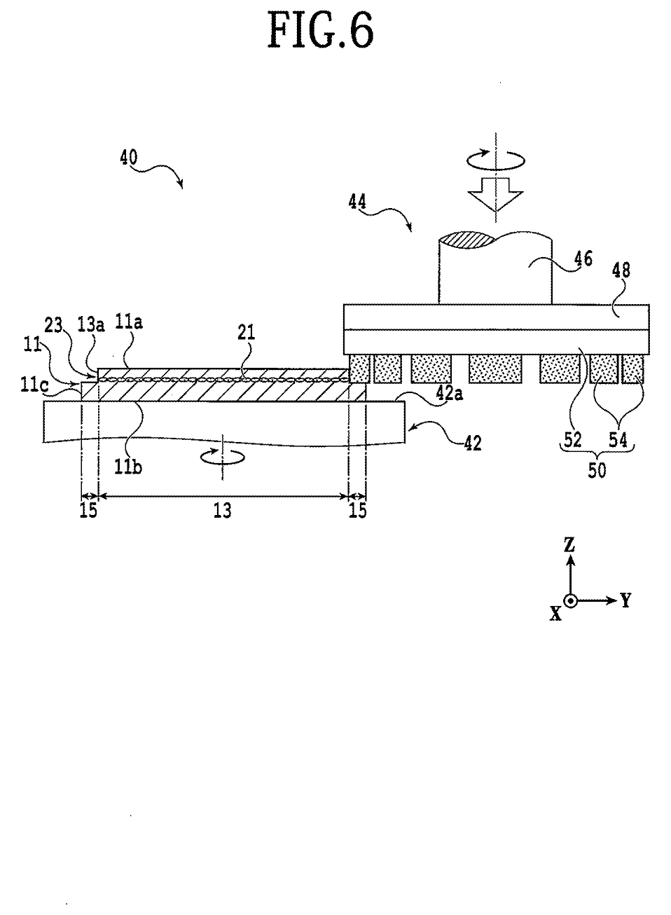

Further alternatively, in exposing step S3, the side surface 13a of the wafer forming region 13 may be exposed by another process than the cutting process performed on the outer circumferential excess region 15 of the ingot 11. FIG. 6 illustrates the ingot 11 during a grinding process performed on the ingot 11 in exposing step S3 in front elevation, partly in cross section. In exposing step S3, for example, a grinding apparatus 40 illustrated in FIG. 6 may be used to perform a grinding process on the ingot 11 to expose the side surface 13a of the wafer forming region 13.

The grinding apparatus 40 includes a chuck table or holding table 42 for holding the ingot 11 thereon. The chuck table 42 has a circular upper surface functioning as a holding surface 42a for holding the ingot 11 thereon. The holding surface 42a is fluidly connected to a suction source, not depicted, such as an ejector, for example, through a fluid channel, not depicted, defined in the chuck table 42 and a valve, not depicted.

The chuck table 42 is coupled to a moving unit, not depicted, that moves the chuck table 42 and a rotary actuator, not depicted, that rotates the chuck table 42. The moving unit includes ball-screw-type moving mechanisms and a turn table, for example, for moving the chuck table 42 in horizontal directions, i.e., in an XY plane along the X-axis and the Y-axis. The rotary actuator includes an electric motor, for example, for rotating the chuck table 42 about its central axis generally parallel to the Z-axis.

The grinding apparatus 40 further includes a grinding unit 44 disposed above the chuck table 42 for performing the grinding process on the ingot 11. The grinding unit 44 includes a cylindrical spindle 46 extending along the Z-axis and a disk-shaped wheel mount 48 fixed to a distal end, i.e., a lower end, of the spindle 46. The wheel mount 48 is made of a metal material such as stainless steel, for example. The spindle 46 has a proximal end portion, i.e., an upper end portion, coupled to a rotary actuator, not depicted, such as an electric motor for rotating the spindle 46 about its central axis generally parallel to the Z-axis.

An annular grinding wheel 50 for grinding the ingot 11 is mounted on a lower surface of the wheel mount 48. The grinding wheel 50 is detachably fastened to the wheel mount 48 by fasteners such as bolts, for example.

The grinding wheel 50 includes an annular wheel base 52 and an annular array of grindstones 54 fixed to the wheel base 52. The wheel base 52 is made of a metal material such as aluminum or stainless steel, for example, and has an outside diameter that is substantially equal to the diameter of the wheel mount 48. The grindstones 54 are fixed to a lower surface of the wheel base 52. The wheel base 52 has an upper surface mounted on a lower surface of the wheel mount 48. For example, the grindstones 54, each of a cuboid shape, are arranged in an annular array and spaced at generally equal intervals along an outer circumferential edge of the wheel base 52. The grindstones 54 have respective lower surfaces that jointly function as an abrasive grinding surface for grinding the ingot 11 in abrasive contact therewith. Each of the grindstones 54 is made of abrasive grains of diamond or cBN, for example, and a binder or bonding material such as a metal bond, a resin bond, or a vitrified bond, for example, that binds the abrasive grains together. However, there is no limitation on the number, shape, material, structure, layout, and size of the grindstones 54.

When the rotary actuator coupled to the spindle 46 is energized, it rotates the spindle 46, the wheel mount 48 and the grinding wheel 50 about a rotational axis generally parallel to the Z-axis. Therefore, the grindstones 54 of the grinding wheel 50 are also rotated along an annular track around the rotational axis.

In exposing step S3, first, the ingot 11 is held on the chuck table 42. Specifically, the ingot 11 is placed on the chuck table 42 such that the first surface 11a is exposed upwardly and the second surface 11b faces the holding surface 42a. Then, the suction source is actuated to apply a suction force, i.e., a negative pressure, to the holding surface 42a to hold the ingot 11 under suction on the chuck table 42.

Then, a positional relation between the ingot 11 and the grinding wheel 50 is adjusted. Specifically, the chuck table 42 is placed beneath the grinding unit 44. At this time, the chuck table 42 and the grinding unit 44 are positioned relatively to each other such that the annular track followed by the grindstones 54 overlaps the outer circumferential excess region 15 rather than the wafer forming region 13 as viewed along the Z-axis.

Thereafter, while the chuck table 42 and the grinding wheel 50 are being rotated about their respective axes at respective speeds, the grinding unit 44 is lowered along the Z-axis. The grindstones 54 as they move along the annular track are brought closer toward the ingot 11 and then into abrasive contact with the first surface 11a side of the outer circumferential excess region 15 of the ingot 11. As a result, the outer circumferential excess region 15 is ground by the grindstones 54. The outer circumferential excess region 15 is continuously ground by the grindstones 54 until the grindstones 54 reach the separation layer 23.

When the grindstones 54 reach the separation layer 23, an annular region that extends radially inwardly from the outer circumferential surface 11c of the ingot 11 to the wafer forming region 13 is ground off. Now, an annular step is formed in the outer circumferential portion of the ingot 11 on the first surface 11a side, exposing a side surface 13a of the wafer forming region 13. As a consequence, an end of the separation layer 23 formed in the ingot 11 is exposed on the side surface 13a of the wafer forming region 13.

In exposing step S3, as described above, a portion of the outer circumferential excess region 15 in which the separation layer 23 has not been formed in separation layer forming step S2 is removed to form the side surface 13a of the wafer forming region 13, exposing the separation layer 23 on the side surface 13a. In this manner, the ingot 11 in which the wafer forming region 13 is formed as a disk-shaped region over the separation layer 23 is obtained.

Exposing step S3 may be carried out before separation layer forming step S2. Specifically, before the separation layer 23 is formed in the ingot 11, the outer circumferential excess region 15 of the ingot 11 is processed to expose a side surface 13a of the wafer forming region 13 in exposing step S3. In this fashion, a cylindrical land including a portion of the wafer forming region 13 is formed in a central region of the ingot 11 (see FIGS. 5A through 6). Thereafter, the laser beam 20 is applied to the ingot 11 while scanning the wafer forming region 13 from one end to the other to form the separation layer 23 in the wafer forming region 13 in separation layer forming step S2. The separation layer 23 thus formed terminates short of the outer circumferential surface 11c of the ingot 11 and is exposed on the side surface 13a of the wafer forming region 13.

If the laser beam 20 is applied to a corner of the ingot 11, i.e., a joint between the first surface 11a and the side surface 13a, then the conditions under which the laser beam 20 is applied to the ingot 11 change, possibly somehow affecting the quality of the separation layer 23 at the end of the wafer forming region 13. Therefore, should a top priority be given to the quality of the separation layer 23, it is preferable to carry out separation layer forming step S2 for forming the separation layer 23 that terminates short of the outer circumferential surface 11c of the ingot 11 prior to exposing step S3 (see FIGS. 4A and 4B). In this fashion, it is possible to avoid applying the laser beam 20 to a corner of the ingot 11, i.e., a joint between the first surface 11a and the side surface 13a.

It has been described above that the outer circumferential excess region 15 of the ingot 11 is processed in an annular pattern. In exposing step S3, however, the outer circumferential excess region 15 may be processed to shape the side surface 13a of the wafer forming region 13 into any desired configuration. In other words, exposing step S3 may double as a step of shaping the side surface 13a of the wafer forming region 13. Specifically, in exposing step S3, the outer circumferential excess region 15 may be removed and a recess, e.g., a notch or an orientation flat, or a mirror surface, indicative of the crystal orientation of the ingot 11 may be formed in a portion of the side surface 13a of the wafer forming region 13. For example, a recess is formed at a predetermined position in a portion of the side surface 13a such that a straight line interconnecting the center of the ingot 11 and the recess extends parallel to or perpendicularly to the crystal orientation of the ingot 11.

For example, after the annular region extending from the outer circumferential surface 11c of the ingot 11 to the wafer forming region 13 has been removed as described above, either one of the cutting blades 38 and 38A (see FIGS. 5A and 5B) may be used to cut off a portion of the side surface 13a of the wafer forming region 13 to form a notch or an orientation flat therein. However, a notch or an orientation flat may alternatively be formed by a processing tool other than cutting blades 38 and 38A or a laser beam applied to the side surface 13a.

Alternatively, a mirror surface, i.e., a flat surface, may be formed in the side surface 13a of the wafer forming region 13 by a cutting process or a laser beam applying process, etc. The mirror surface refers to a planar surface essentially perpendicular to the first surface 11a of the ingot 11 and functions as a mark detectable by an optical sensor. For example, when a reflective optical sensor emits light along the side surface 13a of the wafer forming region 13, the light is applied to the mirror surface and another area of the side surface 13a than the mirror surface. The light reflected from the mirror surface and the light reflected from the other area travel in different directions. Therefore, when the light reflected from the mirror surface and the light reflected from the other area are detected by the optical sensor, the level of intensity of the light reflected from the mirror surface and detected by the optical sensor and the light reflected from the other area and detected by the optical sensor are different from each other. For this reason, the position of the mirror surface can be identified by the level of intensity of the light detected by the optical sensor, and the crystal orientation of the ingot 11 can be recognized from the identified position of the mirror surface.

After separation layer forming step S2 and exposing step S3, the ingot 11 is divided along the separation layer 23 that functions as a separation initiating point to obtain a wafer in separating step S4. The region of the ingot 11 where the separation layer 23 is formed is less mechanically strong and hence more fragile than the other regions of the ingot 11. Therefore, the separation layer 23 functions as a separation initiating point that triggers a process of separating a wafer from the ingot 11. Specifically, when an external force is imposed on the ingot 11, the ingot 11 ruptures along the separation layer 23 that functions as the separation initiating point, separating a wafer having a predetermined thickness from the remainder of the ingot 11.

A separating apparatus, for example, is used to separate a wafer from the ingot 11. FIGS. 7A and 7B illustrate a separating apparatus 60 in front elevation, partly in cross section. The separating apparatus 60 imposes an external force to the ingot 11 to separate a wafer, i.e., a substrate, 25 from the ingot 11.

The separating apparatus 60 includes a chuck table or holding table 62 for holding the ingot 11 thereon. The chuck table 62 has a circular upper surface that lies flatwise generally parallel to a horizontal plane defined as an XY plane along the X-axis and the Y-axis. The upper surface of the chuck table 62 functions as a holding surface 62a for holding the ingot 11 thereon. The holding surface 62a is fluidly connected to a suction source, not depicted, such as an ejector, for example, through a fluid channel, not depicted, defined in the chuck table 62 and a valve, not depicted.

The separating apparatus 60 further includes a separating unit 64 disposed over the chuck table 62. The separating unit 64 includes a holding unit 66 for holding thereon the surface, i.e., the first surface 11a, of the ingot 11 that is opposite the surface, i.e., the second surface 11b, of the ingot 11 that is held on the chuck table 62. The holding unit 66 has a circular lower surface that lies flatwise generally parallel to a horizontal plane defined as an XY plane along the X-axis and the Y-axis. The lower surface of the holding unit 66 functions as a holding surface 66a for holding the ingot 11 thereon.

For example, The holding unit 66 is constructed as a flat disk-shaped holder having a plurality of suction ports, not depicted, for applying a suction force to the ingot 11 to attract the ingot 11 under suction to the holding surface 66a. The suction ports have lower ends that are open at the holding surface 66a and upper ends fluidly connected to a suction source, not depicted, such as an ejector, for example, through a fluid channel, not depicted, defined in the holding unit 66. The number and layout of the suction ports are established such that the suction ports can be closed by the ingot 11 when the ingot 11 is held in contact with the holding surface 66a.

The holding unit 66 has an upper surface coupled to a support rod 68 that supports the holding unit 66. The support rod 68 has a lower end fixed to a central area of the holding unit 66. The support rod 68 has an upper end coupled to a moving unit, not depicted, for moving the support rod 68. The moving unit includes a ball-screw-type moving mechanism, for example, for moving the support rod 68 together with the holding unit 66 vertically along the Z-axis, i.e., lifting and lowering them along the Z-axis.

FIG. 7A illustrates the separating apparatus 60 that is holding the ingot 11 in front elevation, partly in cross section. In separating step S4, first, the ingot 11 is held by the chuck table 62 and the holding unit 66.

Specifically, the ingot 11 is placed on the chuck table 62 while a space whose vertical dimension is larger than the thickness of the ingot 11 is being left between the holding surface 62a of the chuck table 62 and the holding surface 66a of the holding unit 66. At this time, the ingot 11 is placed on the chuck table 62 such that the first surface 11a is exposed upwardly and the second surface 11b faces the holding surface 62a. Then, the suction source fluidly connected to the chuck table 62 is actuated to apply a suction force, i.e., a negative pressure, to the holding surface 62a to hold the ingot 11 under suction on the chuck table 62. Thereafter, the holding unit 66 is lowered along the Z-axis by the moving unit until the holding surface 66a is brought into contact with the first surface 11a of the ingot 11. Then, the suction source fluidly connected to the holding unit 66 is actuated to apply a suction force, i.e., a negative pressure, to the holding surface 66a to hold the ingot 11 under suction on the holding unit 66. Now, the ingot 11 has the second surface 11b securely held on the holding surface 62a and the first surface 11a securely held on the holding surface 66a.

FIG. 7B illustrates the separating apparatus 60 that is separating a wafer 25 from the ingot 11 in front elevation, partly in cross section. After the ingot 11 is securely held by the chuck table 62 and the holding unit 66, the chuck table 62 is secured in position, and the holding unit 66 is lifted along the Z-axis by the moving unit, not depicted. The holding surface 62a and the holding surface 66a are now spaced from each other, exerting an external force to the ingot 11 for separating the first surface 11a side and the second surface 11b side of the ingot 11 away from each other. As a result, the ingot 11 is divided along the separation layer 23 that functions as a separation initiating point, separating the first surface 11a side, i.e., the wafer forming region 13 over the separation layer 23, of the ingot 11 as a wafer 25 from the remainder of the ingot 11.

In this fashion, the plate-shaped wafer 25 is fabricated from the ingot 11. The depth where the separation layer 23 is formed in the ingot 11 before the wafer 25 is separated from the ingot 11, i.e., the distance between the first surface 11a of the ingot 11 and the separation layer 23, corresponds to the thickness of the wafer 25 separated from the ingot 11.

Because of the action of the laser beam 20 (see FIGS. 4A and 4B) applied to the ingot 11 in separation layer forming step S2, an internal force, i.e., an internal stress, may be developed in the separation layer 23 and its vicinity, tending to divide the wafer forming region 13 of the ingot 11 along the separation layer 23 that functions as a separation initiating point. In addition, on account of an external force applied to the ingot 11 by the cutting blade 38 or 38A or the grinding wheel 50 brought into contact with the ingot 11 at the time the ingot 11 is processed in exposing step S3 (see FIGS. 5A through 6), the wafer forming region 13 of the ingot 11 may be divided along the separation layer 23 that functions as a separation initiating point, separating the wafer 25 from the ingot 11. If either one of these dividing processes happens, then since the wafer 25 has been fabricated upon completion of exposing step S3, separating step S4 described above may be dispensed with.

However, if the wafer forming region 13 is divided in separation layer forming step S2 or exposing step S3, the wafer forming region 13, i.e., the wafer 25, separated from the ingot 11 may be expelled and damaged while the ingot 11 is being processed in exposing step S3. In exposing step S3, therefore, it is preferable to process the outer circumferential excess region 15 while the first surface 11a side of the ingot 11 is being fixed in position by a fixing component.

The fixing component used to fix the first surface 11a side of the ingot 11 in position may be of any of various structures. For example, a holding table for holding the ingot 11 thereon may be used as the fixing component. The holding table is freely rotatable together with the ingot 11 and includes a holding surface for holding the first surface 11a side of the ingot 11 thereon. The holding surface of the holding table is fluidly connected to a suction source, not depicted, through a fluid channel, not depicted, defined in the holding table.

In exposing step S3, the holding surface of the holding table is held in contact with the first surface 11a side of the ingot 11, and the suction source is actuated to apply a suction force, i.e., a negative pressure, to the holding surface, thereby holding the first surface 11a side of the ingot 11 under suction on the holding table. Since the first surface 11a side of the ingot 11 is thus fixed in position, the wafer 25 that may have been separated from the ingot 11 while the outer circumferential excess region 15 is being processed is prevented from being expelled.

The holding surface may be of any shape and size so long as it can hold the wafer 25. For example, the holding surface may be of a circular or polygonal shape. Moreover, the holding surface may hold the first surface 11a side of the ingot 11 in its entirety or may hold a portion, e.g., a central portion, of the first surface 11a side of the ingot 11.

The fixing component may alternatively be a pressor for pressing the first surface 11a side of the ingot 11. The presser is of a columnar shape, for example, and disposed in a position overlapping the ingot 11. The presser is coupled to a moving mechanism for lifting and lowering a distal end of the presser. When the moving mechanism is actuated, it moves the distal end of the presser selectively into a position, i.e., a pressing position in which the distal end of the presser is in pressing contact with the first surface 11a side of the ingot 11 to press the ingot 11 and a position, i.e., a releasing position, in which the distal end of the presser is kept out of contact with the first surface 11a side of the ingot 11 to release the ingot 11.

In exposing step S3, the distal end of the presser is positioned in the pressing position to hold the first surface 11a side of the ingot 11 in place. Consequently, the wafer 25 that may have been separated from the ingot 11 while the outer circumferential excess region 15 is being processed is prevented from being expelled. The fixing component may further alternatively be a plurality of pressers for pressing the first surface 11a side of the ingot 11 at two or more locations thereon.

The wafer 25 separated from the ingot 11 may be used in the fabrication of device chips, for example. Specifically, the surface, i.e., the separated surface, of the wafer 25 that has been separated from the ingot 11 is ground and polished, removing or reducing separation marks, i.e., surface irregularities, remaining on the separated surface of the wafer 25.

Then, a plurality of rectangular areas are demarcated on the wafer 25 by a grid of intersecting streets or projected dicing lines. Thereafter, devices such as integrated circuits (ICs), large-scale-integration (LSI) circuits, light-emitting diodes (LEDs), or micro-electro-mechanical-systems (MEMS) devices, for example, are constructed in the respective areas demarcated by streets on the wafer 25. Then, the wafer 25 is divided along the streets into individual pieces as device chips including the respective devices by a cutting apparatus or a laser processing apparatus, for example.

When the wafer 25 is separated from the ingot 11, the surface, i.e., the separating surface, of the ingot 11 from which the wafer 25 has been separated becomes a new first surface 11a of the ingot 11. The ingot 11 is then used again to manufacture a next wafer 25 therefrom. At this time, the ingot 11 should preferably be processed to planarize the first surface 11a side, i.e., the separating surface side, of the ingot 11 in a planarizing step. In the planarizing step, separation marks, i.e., surface irregularities, left on the first surface 11a side of the ingot 11 are removed or reduced, lowering the surface roughness of the first surface 11a of the ingot 11.

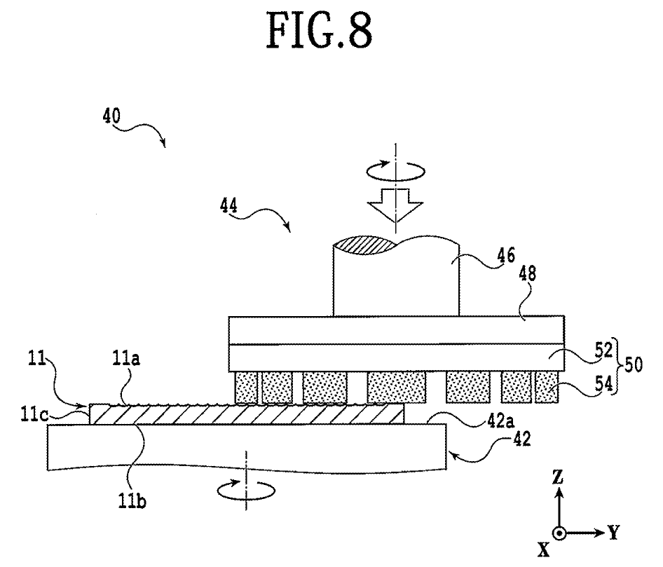

FIG. 8 illustrates the ingot 11 in the planarizing step in front elevation, partly in cross section. In the planarizing step, the grinding apparatus 40 illustrated in FIG. 6, for example, is used to perform a grinding process on the ingot 11 to remove or reduce separation marks, i.e., surface irregularities, left on the first surface 11a side of the ingot 11, thereby planarizing the first surface 11a of the ingot 11. The structural details and function of the grinding apparatus 40 have been described above with respect to exposing step S3 (see FIG. 6).

In the planarizing step, the ingot 11 is held on the chuck table 42. Specifically, the ingot 11 is placed on the chuck table 42 such that the first surface 11a, i.e., the separating surface or a surface to be ground, is exposed upwardly and the second surface 11b faces the holding surface 42a. Then, a suction force, i.e., a negative pressure, from the suction source is applied to the holding surface 42a to hold the ingot 11 under suction on the chuck table 42.

Then, the chuck table 42 is placed beneath the grinding unit 44. At this time, the positional relation between the ingot 11 and the grinding wheel 50 is adjusted such that rotational axis of the chuck table 42, i.e., the center of the ingot 11, and the annular track followed by the grindstones 54 overlap each other along the Z-axis. Thereafter, while the chuck table 42 and the grinding wheel 50 are being rotated about their respective axes at respective speeds, the grinding unit 44 is lowered along the Z-axis. The grindstones 54 as they move along the annular track are brought closer toward the ingot 11 and then into abrasive contact with the first surface 11a side of the ingot 11.

When the grindstones 54 are brought into abrasive contact with the first surface 11a side of the ingot 11, the first surface 11a side of the ingot 11 is ground off. The surface irregularities that are left on the first surface 11a side of the ingot 11 are thus removed or reduced. After the ingot 11 is ground to a predetermined thickness, the grinding unit 44 is lifted, putting a stop to the grinding process.

The planarizing step thus carried out planarizes the first surface 11a side of the ingot 11. In the planarizing step, a polishing process may be performed on the ingot 11 in addition to or instead of the grinding process. For example, while a polishing liquid is being supplied to the first surface 11a side of the ingot 11, a disk-shaped polishing pad is applied to polish the first surface 11a side of the ingot 11. The first surface 11a side of the ingot 11 is thus further planarized and turned into a mirror surface.

Thereafter, the ingot 11 is then used again to manufacture a next wafer 25 therefrom. Specifically, separation layer forming step S2, exposing step S3, and separating step S4 are performed on the ingot 11 to produce a new wafer 25. At this time, if the planarizing step has been carried out, then the laser beam 20 (see FIG. 4A) finds it easy to enter the first surface 11a side of the ingot 11 because it has been planarized.

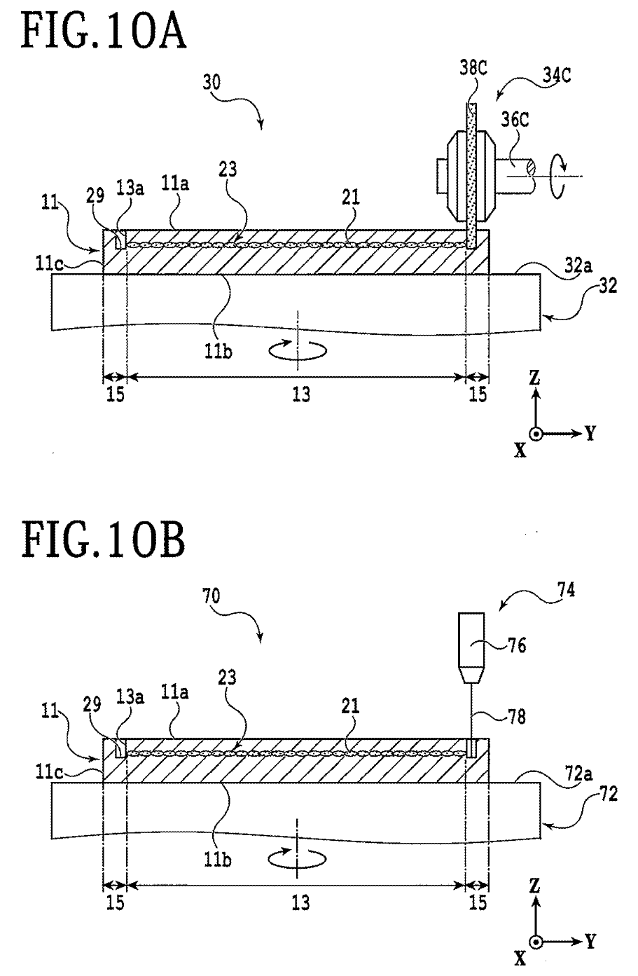

As described above, the method of manufacturing a wafer according to the present embodiment is carried out by a wafer manufacturing system including a plurality of processing apparatuses. Specifically, according to the present embodiment, the wafer manufacturing system includes the laser processing apparatus 10 (see FIG. 4A) for carrying out separation layer forming step S2, the exposing apparatus, i.e., the cutting apparatus 30 (see FIGS. 5A, 5B, 9, and 10A), the grinding apparatus 40 (see FIG. 6), and the laser processing apparatus 70 (see FIG. 10B), for carrying out exposing step S3, and the separating apparatus 60 (see FIGS. 7A and 7B) for carrying out separating step S4. These processing apparatuses successively process the ingot 11 to manufacture the wafer 25 from the ingot 11.

The wafer manufacturing system is not restricted to any specific configurations. For example, the wafer manufacturing system may be made up of the laser processing apparatus 10, the exposing apparatus, and the separating apparatus 60 as independent apparatuses that are installed in one factory, and these processing apparatuses may cooperate with each other to manufacture the wafer 25 from the ingot 11. Alternatively, the wafer manufacturing system may be a single complex processing apparatus that incorporates the laser processing apparatus 10, the exposing apparatus, and the separating apparatus 60. Further alternatively, the wafer manufacturing system may further include the grinding apparatus 40 (see FIG. 8) for carrying out the planarizing step.

With the method of manufacturing a wafer and the wafer manufacturing system according to the present embodiment, the separation layer 23 that functions as a separation initiating point for separating the wafer 25 from the ingot 11 is formed in the ingot 11 such that the separation layer 23 terminates short of the outer circumferential surface 11c of the ingot 11. The laser beam 20 for forming the separation layer 23 is thus not applied to crystal defects that may occur in the outer circumferential surface 11c and its vicinity, resulting in an increase in the quality of the separation layer 23. As a consequence, the wafer 25 can easily be separated from the ingot 11.

The steps of the method of manufacturing a wafer according to the present embodiment may be changed or modified to the extent that the quality of the separation layer 23 is prevented from being lowered by crystal defects that may occur in the outer circumferential surface 11c of the ingot 11 and its vicinity. For example, the features of the processing performed on the outer circumferential excess region 15 of the ingot 11 in exposing step S3 are not limited to the cutting process and the grinding process illustrated in FIGS. 5A through 6. A modification of exposing step S3 will be described below.

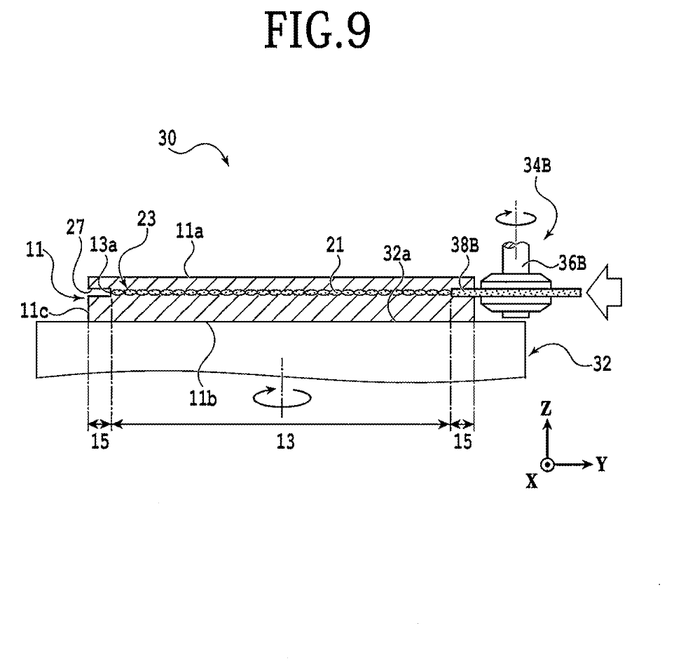

FIG. 9 illustrates the ingot 11 in exposing step S3 according to a first modification in front elevation, partly in cross section. In exposing step S3 according to the first modification, a side surface of the wafer forming region 13 may be exposed by forming a groove 27 in the ingot 11 that extends from the outer circumferential surface 11c to the wafer forming region 13.

For example, the groove 27 is formed in the ingot 11 by cutting the ingot 11 with a cutting apparatus 30 including a cutting unit 34B illustrated in FIG. 9. The cutting apparatus 30 illustrated in FIG. 9 is different from the cutting apparatus 30 illustrated in FIG. 5A in that it includes the cutting unit 34B in place of the cutting unit 34 (see FIG. 5A). The cutting unit 34B is similar in structure and function to the cutting unit 34 except for details to be described below.

The cutting unit 34B includes a cylindrical spindle 36B extending along the Z-axis. The spindle 36 has a distal end portion, i.e., an end portion, on which an annular cutting blade 38B for cutting the ingot 11 is mounted. The cutting blade 38B may be a hub blade or a washer blade. The cutting blade 38B has a thickness smaller than the depth of the separation layer 23, i.e., the distance from the first surface 11a of the ingot 11 to the separation layer 23.

The spindle 36B has a proximal end portion, i.e., an opposite end portion, coupled to a rotary actuator, not depicted, such as an electric motor for rotating the spindle 36B about its central axis generally parallel to the Z-axis. When the rotary actuator is energized to rotate the spindle 36B about its central axis, the cutting blade 38B is rotated about its central axis generally parallel to the Z-axis.

In exposing step S3, a positional relation between the ingot 11 held on the chuck table 32 and the cutting blade 38B is adjusted. Specifically, the chuck table 32 and/or the cutting unit 34B are/is adjusted in position such that the cutting blade 38B is placed alongside of the ingot 11. At this time, the cutting unit 34B is placed to align the vertical position of the separation layer 23 in the ingot 11 and the vertical position of the cutting blade 38B with each other.

Then, while the chuck table 32 and the cutting blade 38B are being rotated about their respective central axes, the chuck table 32 and the cutting unit 34B are moved relatively to each other in directions to bring the ingot 11 and the cutting blade 38B closer toward each other. For example, the cutting unit 34B is moved along the Y-axis toward the ingot 11 to bring the rotating cutting blade 38B into contact with the outer circumferential surface 11c of the ingot 11. The rotating cutting blade 38 is continuously moved to cut into the outer circumferential surface 11c, so that the outer circumferential surface 11c is cut in an annular pattern circumferentially around the ingot 11.

Thereafter, while the chuck table 32 and the cutting blade 38B are kept in rotation, the chuck table 32 and the cutting unit 34B are further moved relatively to each other to bring the cutting blade 38B toward the center of the ingot 11. The outer circumferential excess region 15 of the ingot 11 is thus progressively cut from the outer circumferential surface 11c toward the center of the ingot 11. The ingot 11 is continuously cut until the cutting blade 38B reaches the wafer forming region 13.

When the cutting blade 38B reaches the wafer forming region 13, an annular groove 27 that extends radially inwardly from the outer circumferential surface 11c to the wafer forming region 13 is formed circumferentially in the ingot 11, removing a region extending radially inwardly from the outer circumferential surface 11c to the wafer forming region 13 from the ingot 11. As a consequence, the side surface 13a of the wafer forming region 13 is exposed, and an end of the separation layer 23 formed in the ingot 11 is exposed on the side surface 13a of the wafer forming region 13.

Thereafter, in separating step S4, the ingot 11 is divided to produce a wafer 25 (see FIG. 7B). According to the first modification illustrated in FIG. 9, a portion of the outer circumferential excess region 15 that exists above the groove 27, i.e., on the first surface 11a side of the ingot 11, is included as part of the wafer 25 in addition to the wafer forming region 13. The wafer 25 thus fabricated from the ingot 11 has the same diameter as the ingot 11.

In separating step S4, alternatively, a groove having a depth from the first surface 11a of the ingot 11 to the separation layer 23 may be formed in the ingot 11 along an outer circumferential edge of the wafer forming region 13. The ingot 11 in exposing step S3 according to a second modification is illustrated in FIGS. 10A and 10B.

FIG. 10A illustrates the ingot 11 while a groove 29 is being formed therein by a cutting process in exposing step S3 according to the second modification. In exposing step S3 according to the second modification, a cutting apparatus 30 that includes a cutting unit 34C cuts the ingot 11 to form the groove 29 in the ingot 11. As illustrated in FIG. 10A, the cutting apparatus 30 includes the cutting unit 34C in place of the cutting unit 34 (see FIG. 5A). The cutting unit 34C is similar in structure and function to the cutting unit 34 except for details to be described below.

The cutting unit 34C includes a cylindrical spindle 36C extending along the Y-axis and an annular cutting blade 38C for cutting the ingot 11, fixedly mounted on a distal end portion, i.e., one end portion, of the spindle 36C. The cutting blade 38C may be a hub blade or a washer blade. The cutting blade 38C has a thickness smaller than the width of the outer circumferential excess region 15, i.e., the distance from the outer circumferential surface 11c to the boundary between the wafer forming region 13 and the outer circumferential excess region 15.

The spindle 36C has a proximal end portion, i.e., an opposite end portion, coupled to a rotary actuator, not depicted, such as an electric motor for rotating the spindle 36C about its central axis generally parallel to the Y-axis. When the rotary actuator is energized to rotate the spindle 36C about its central axis, the cutting blade 38C is rotated about its central axis generally parallel to the Y-axis.

In exposing step S3, a positional relation between the ingot 11 held on the chuck table 32 and the cutting blade 38C is adjusted. Specifically, the chuck table 32 and/or the cutting unit 34C are/is adjusted in position such that the cutting blade 38C is disposed in overlapping relation to or adjacent to the separation layer 23 in the ingot 11 along the Z-axis. For example, the cutting unit 34C is positionally adjusted such that the cutting blade 38C has a side surface positioned directly above the boundary between the wafer forming region 13 and the outer circumferential excess region 15.

Then, while the chuck table 32 and the cutting blade 38C are being rotated about their respective central axes, the cutting unit 34C is lowered along the Z-axis to move the ingot 11 and the cutting blade 38C relatively to each other along the Z-axis. The rotating cutting blade 38C now cuts into the first surface 11a side of the ingot 11, cutting the first surface 11a in an annular pattern. The ingot 11 is continuously cut by the cutting blade 38C until the cutting blade 38C reaches the separation layer 23.

When the lowermost end of the cutting blade 38C reaches the separation layer 23, an annular groove 29 extending from the first surface 11a of the ingot 11 to the separation layer 23 is formed in the ingot 11 along an outer circumferential edge thereof. As a consequence, a side surface 13a of the wafer forming region 13 that is represented by a side wall of the groove 29 is exposed, exposing an end of the separation layer 23 on the side surface 13a of the wafer forming region 13.

FIG. 10B illustrates the ingot 11 while a groove 29 is being formed therein by a laser beam applying process in front elevation, partly in cross section. The groove 29 may be formed in the ingot 11 by the laser beam applying process. For example, a laser processing apparatus 70 may be used to perform an ablation process on the ingot 11 to form the groove 29 therein. The laser processing apparatus 70 is similar in structure and function to the laser processing apparatus 10 (see FIG. 4A) except for details to be described below.

The laser processing apparatus 70 includes a chuck table or holding table 72 having a holding surface 72a for holding the ingot 11 thereon and a laser beam applying unit 74 having a laser processing head 76 for applying a laser beam 78 to the ingot 11. The details of the chuck table 72 and the laser beam applying unit 74 are identical to those of the chuck table 12 and the laser beam applying unit 14 (see FIG. 4A).

In exposing step S3, first, a positional relation between the ingot 11 held on the chuck table 72 and the laser processing head 76 is adjusted. Specifically, the chuck table 72 and/or the laser processing head 76 are/is positionally adjusted such that the laser processing head 76 overlaps the ingot 11 along the Z-axis. Moreover, the focused spot of the laser beam 78 emitted from the laser processing head 76 is positioned at the boundary between the wafer forming region 13 and the outer circumferential excess region 15 or its vicinity.

Then, while the chuck table 72 is being rotated about its central axis, the laser processing head 76 emits the laser beam 78 toward the ingot 11. The laser beam 78 is applied to the first surface 11a side of the ingot 11 while scanning it annularly along the outer circumferential edge of the wafer forming region 13.

The laser beam 78 is applied to the ingot 11 under such conditions as to perform an ablation process on a region of the ingot 11 to which the laser beam 78 is applied, i.e., an irradiated region of the ingot 11. More specifically, the wavelength of the laser beam 78 is set such that at least part of the laser beam 78 is absorbed by the ingot 11. In other words, the laser beam 78 is a pulsed laser beam that is absorbable by the ingot 11. Other conditions under which to apply the laser beam 78 to the ingot 11 are established to perform an appropriate ablation process on the ingot 11.

When the laser beam 78 is applied to the ingot 11 as described above, it forms an annular groove 29 in the first surface 11a of the ingot 11 along the outer circumferential edge of the wafer forming region 13. The laser beam 78 is continuously applied to the ingot 11 until the annular groove 29 reaches the separation layer 23. In this manner, the annular groove 29 that extends from the first surface 11a of the ingot 11 to the separation layer 23 is formed in annular pattern along the outer circumferential edge of the wafer forming region 13. The groove 29 can thus be formed in the ingot 11 by the laser beam applying process.

After the groove 29 is formed in the ingot 11 in exposing step S3 as described above, separating step S4 is carried out on the ingot 11. In separating step S4, a disk-shaped region of the ingot 11 that is surrounded by the annular groove 29 is separated from the ingot 11 along the separation layer 23 that functions as a separation initiating point. Therefore, the wafer 25 (see FIG. 7B) is obtained.

When the wafer 25 is separated from the ingot 11 with the groove 29 formed therein, the outer circumferential excess region 15 that exists radially outwardly of the groove 29 remains unremoved as an annular ridge. For using the ingot 11 again to manufacture a next wafer 25 therefrom, the outer circumferential portion of the ingot 11 is cut, ground, and processed with a laser beam, etc., to remove the annular ridge from the ingot.

When the groove 29 is formed in the ingot 11 in exposing step S3, an external force may be applied to the ingot 11 by the cutting blade 38C contacting the ingot 11 (see FIG. 10A) or the laser beam 78 applied to the ingot 11 (see FIG. 10B), possibly tending to separate a wafer 25 from the ingot 11 as described above. Since the chuck tables 32 and 72 are rotated at a relatively low speed at the time of forming the groove 29 in the ingot 11 and in addition the annular ridge remaining in the outer circumferential portion of the ingot 11 functions as a wall, it is not likely for the separated wafer 25 to be expelled from the ingot 11.

If the laser beam 78 is applied to the ingot 11 to form the groove 29 therein (see FIG. 10B), the chuck table 72 may not be moved and rotated, but the focused spot of the laser beam 78 may be moved to form the groove 29 in the ingot 11. Inasmuch as the groove 29 is formed in the ingot 11 without moving the ingot 11, the wafer 25 that may have been separated from the ingot 11 is more unlikely to be expelled from the ingot 11.

According to the present embodiment, separation layer forming step S2, exposing step S3, separating step S4, and the planarizing step have been described as being performed on the ingot 11 held on respective different chuck tables (see FIGS. 4A through 10). In this case, the ingot 11 is transferred from one chuck table to another chuck table automatically by a transfer mechanism or manually by an operator between every two of the steps. However, the ingot 11 may be held on one chuck table in two or more of separation layer forming step S2, exposing step S3, separating step S4, and the planarizing step. In this case, the chuck table that is holding the ingot 11 may be moved by a moving mechanism to transfer the ingot 11 between the two or more of the steps.

The structural and methodical features of the present embodiment may be changed or modified without departing from the scope of the present invention.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A method of manufacturing a wafer from a crystalline ingot, the method comprising:
preparing the ingot that has a wafer forming region corresponding to the wafer and an outer circumferential excess region including an outer circumferential surface of the ingot and surrounding the wafer forming region;
while a focused spot of a laser beam that is transmittable through the ingot is being positioned within the ingot, applying the laser beam to a region of the ingot that is disposed inwardly of the outer circumferential surface of the ingot while, at the same time, moving the ingot and the focused spot relatively to each other, thereby forming a separation layer that terminates short of the outer circumferential surface of the ingot within at least the wafer forming region of the ingot; and
processing the outer circumferential excess region of the ingot to expose a side surface of the wafer forming region.

2. The method of manufacturing a wafer according to claim 1, wherein
the side surface of the wafer forming region is exposed after the forming the separation layer, and
the exposing the side surface of the wafer forming region includes exposing the separation layer on the side surface of the wafer forming region.

3. The method of manufacturing a wafer according to claim 1, further comprising:
dividing the ingot along the separation layer that functions as a separation initiating point to produce the wafer from the ingot after the forming the separation layer and the exposing the side surface of the wafer forming region.

4. The method of manufacturing a wafer according to claim 1, wherein
the preparing the ingot includes
inspecting the ingot to determine whether or not there is an anomalous section including at least one of a crystal defect region where a crystal defect exists, a polymorphism region that has its crystal form different from the crystal form of another region, or an anomalous concentration region where concentration of an impurity contained in the ingot falls out of an allowable range, and,
if it is decided that the anomalous section exists in a predetermined range from the outer circumferential surface of the ingot, establishing the outer circumferential excess region in order for the outer circumferential excess region to contain the anomalous section.

5. The method of manufacturing a wafer according to claim 1, wherein the exposing the side surface of the wafer forming region includes removing a region extending from the outer circumferential surface of the ingot to the wafer forming region.

6. The method of manufacturing a wafer according to claim 1, wherein the exposing the side surface of the wafer forming region includes forming a groove having a depth from a surface of the ingot to the separation layer along an outer circumferential edge of the wafer forming region.

7. A wafer manufacturing system for manufacturing a wafer from a crystalline ingot, the system comprising:
a laser processing apparatus for, in a state where a focused spot of a laser beam that is transmittable through the ingot that has a wafer forming region corresponding to the wafer and an outer circumferential excess region including an outer circumferential surface of the ingot and surrounding the wafer forming region is being positioned within the ingot, applying the laser beam to a region of the ingot that is disposed inwardly of the outer circumferential surface of the ingot while, at the same time, moving the ingot and the focused spot relatively to each other, thereby forming a separation layer that terminates short of the outer circumferential surface of the ingot within at least the wafer forming region of the ingot; and
an exposing apparatus for processing the outer circumferential excess region of the ingot to expose a side surface of the wafer forming region.

8. The wafer manufacturing system according to claim 7, further comprising:
a separating apparatus for dividing the ingot along the separation layer that functions as a separation initiating point.
